(19) United States
(12) Patent Application Publication
(10) Pub. No.: US 2026/0086412 A1
(43) Pub. Date: Mar. 26, 2026

(54) DISPLAY PANEL

(71) Applicant: HANNSTAR DISPLAY CORPORATION, Taipei City (TW)

(72) Inventors: Qi-En Luo, Chiayi County (TW); Cheng-Yen Yeh, Taichung City (TW); Ling-Chih Kao, New Taipei City (TW); Shao-Chien Chang, Taoyuan City (TW); Jing-Ya Chiu, Tainan City (TW); Ying-Jung Chen, New Taipei City (TW)

(73) Assignee: HANNSTAR DISPLAY CORPORATION, Taipei City (TW)

(21) Appl. No.: 18/957,893

(22) Filed: Nov. 25, 2024

(30) Foreign Application Priority Data
Sep. 20, 2024 (TW) 113135605

(51) Int. Cl. G02F 1/1368; G02F 1/1335; G02F 1/1343; G02F 1/1362

(52) U.S. Cl. CPC G02F 1/1368; G02F 1/133514; G02F 1/133553; G02F 1/134309; G02F 1/136286; G02F 2203/02

(57) ABSTRACT

A display panel is provided and includes a dual-gate array substrate, which includes a substrate, a plurality of gate lines, a plurality of data lines, and a plurality of pixel structures. The gate lines, the data lines, and the pixel structures are disposed on the substrate. Each of the pixel structures includes a thin film transistor and a pixel electrode. A gate, a source, and a drain of the thin film transistor are coupled to one of the gate lines, one of the data lines, and the pixel electrode, respectively. The source and the drain of each of the pixel structures are sequentially arranged along a same direction.

### BACKGROUND OF THE INVENTION

### 1. Field of the Invention

The present invention relates to a display panel, and particularly to a display panel including a dual-gate array substrate.

### 2. Description of the Prior Art

Recently, as the resolution of display panels has increased, the number of source driver chips has also increased, which raises the manufacturing cost of the display panels. For this reason, a dual-gate display panel has been developed, in which the same data line is electrically connected to thin-film transistors in pixel structures of at least two columns to reduce the number of data lines, thereby decreasing the number of source driver chips. However, thin-film transistors in different pixel structures easily have different coupling capacitances between the gate and the drain due to process variation, such that the voltage drops of the pixel voltages of different pixel structures are also different, causing the problem of uneven brightness. Therefore, how to reduce the influence of process variation on the coupling capacitances between the gate and the drain of different thin-film transistors is a critical issue in the art.

### SUMMARY OF THE INVENTION

It is one of the main objectives of the present invention to provide a display panel to reduce or avoid uneven brightness caused by process variation.

According to an embodiment of the present invention, a display panel is provided and includes a dual-gate array substrate. The dual-gate array substrate includes a first substrate, a plurality of gate lines, a plurality of data lines, and a plurality of pixel structures. The gate lines, the data lines, and the pixel structures are disposed on the first substrate. Each of the pixel structures includes a thin film transistor and a pixel electrode. A gate of the thin film transistor is coupled to one of the gate lines, and a source of the thin film transistor is coupled to one of the data lines. The pixel electrode is coupled to a drain of the thin film transistor. The source and the drain of each of the pixel structures are sequentially arranged along a same direction.

In the display panel of the present invention, by arranging the source and the drain of each pixel structure sequentially along the same direction, when the relative positions of the source and the drain with respect to the gate of each pixel structure is shifted during manufacturing processes, the overlapping areas of the drains and the gates of different pixel structures may be increased or decreased simultaneously, thereby reducing the differences in coupling capacitance between the drain and the gate of different pixel structures. Accordingly, the brightness uniformity of the display panel can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 schematically illustrates a part of a single gate array substrate.

FIG. 2A to FIG. 2C schematically illustrate parts of plural examples of a dual-gate array substrate according to a first embodiment of the present invention.

FIG. 3 schematically illustrates a partial top view of a dual-gate array substrate of a display panel according to the first embodiment of the present invention.

FIG. 4 is a partial cross-sectional schematic diagram of the display panel according to the first embodiment of the present invention.

FIG. 5A and FIG. 5B respectively illustrate top views of another example of the thin film transistors of the pixel structures of the display panel according to the first embodiment.

FIG. 6A and FIG. 6B schematically illustrate partial top views of different pixel structures of FIG. 3 when there is no alignment error in the manufacturing processes.

FIG. 7A and FIG. 7B illustrate partial top views of different pixel structures of FIG. 3 when there is an alignment error in the manufacturing processes.

FIG. 8 schematically illustrates a partial top view structure of a display panel according to a second embodiment of the present invention.

FIG. 9A and FIG. 9B schematically illustrate partial top views of different pixel structures of FIG. 8 when there is no alignment error in the manufacturing processes.

FIG. 10A and FIG. 10B schematically illustrate partial top views of different pixel structures of FIG. 8 when there is an alignment error in the manufacturing processes.

FIG. 11 schematically illustrates a partial top view of a color filter substrate of a reflective-type display panel according to a third embodiment of the present invention.

FIG. 12 schematically illustrates a partial top view of a dual-gate array substrate of the reflective-type display panel according to the third embodiment of the present invention.

FIG. 13 schematically illustrates a top view of pixels of the reflective-type display panel according to the third embodiment of the present invention.

FIG. 14 schematically illustrates a top view of a pixel and spacers of a reflective-type display panel according to a fourth embodiment of the present invention.

FIG. 15 schematically illustrates a partial cross-sectional schematic diagram of the reflective-type display panel according to the fourth embodiment of the present invention.

FIG. 16 schematically illustrates a top view of a pixel and spacers of a reflective-type display panel according to a variant embodiment of a fourth embodiment of the present invention.

### DETAILED DESCRIPTION

In order to make the person having ordinary skill in the art further understand the present invention, embodiments of the present invention are listed below, and the composition and intended effects of the present invention will be described in detail with reference to the accompanying drawings. It should be noted that the drawings are simplified schematic diagrams, and therefore, only the components and combination relationships related to the present invention are shown to provide a clearer description of the basic architecture or implementation method of the present invention, while the actual components and layout may be more complicated. In addition, for convenience of explanation, the components shown in the various drawings of the present invention are not drawn to the actual number, shape and size, and the detailed scale can be adjusted according to the design requirements.

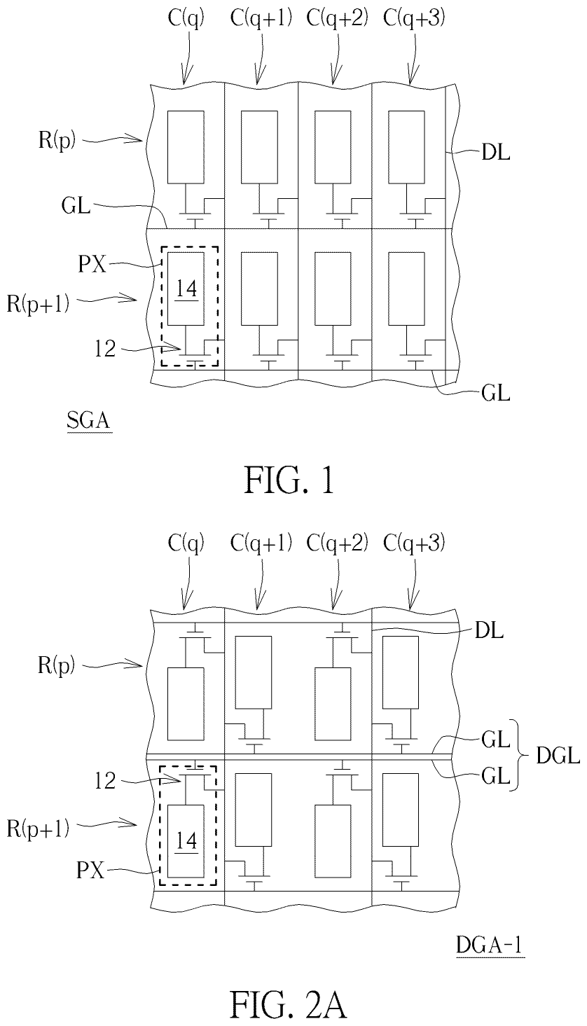

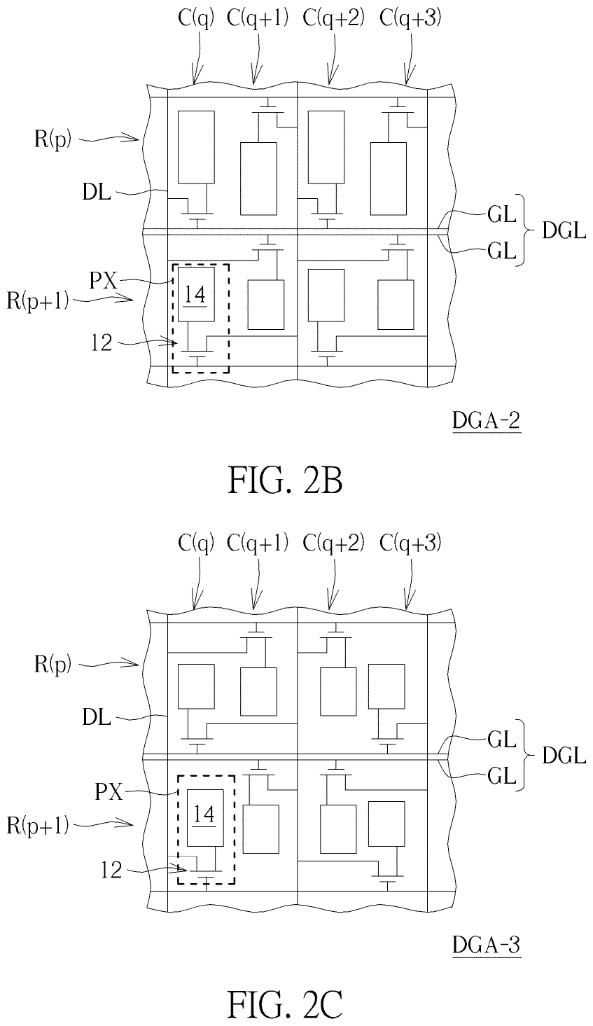

FIG. 1 schematically illustrates a part of a single gate array substrate, and FIG. 2A to FIG. 2C schematically illustrate parts of plural examples of a dual-gate array substrate according to a first embodiment of the present invention. As shown in FIG. 1 and FIG. 2A to FIG. 2C, each of the single gate array substrate SGA and the dual-gate array substrates DGA-1, DGA-2, DGA-3 includes a plurality of gate lines GL, a plurality of data lines DL, and a plurality of pixel structures PX, and each of the pixel structures PX includes a thin film transistor 12 and a pixel electrode 14 electrically connected to each other. The pixel structures PX are arranged into a plurality of pixel structure rows and a plurality of pixel structure columns, wherein the pixel structure rows include a pixel structure row R(p) and a pixel structure row R(p+1), and the pixel structure columns include pixel structure columns C(q), C(q+1), C(q+2), and C(q+3). As shown in FIG. 1, in the single-gate array substrate SGA, only one gate line GL is disposed between any two adjacent pixel structure rows, and only one pixel structure column is disposed between any two adjacent data lines DL. As shown in FIG. 2A to FIG. 2C, in each of the dual-gate array substrates DGA-1, DGA-2, and DGA-3, a group of dual gate lines DGL is disposed between two adjacent pixel structure rows, the group of dual gate lines DGL includes two gate lines GL adjacent to each other, and two pixel structure columns are disposed between two adjacent data lines DL. In addition, in the single-gate array substrate SGA, one gate line GL is coupled to all pixel structures PX of one pixel structure row, and one data line DL is coupled to all pixel structures PX of only one pixel structure column. In each of the dual-gate array substrates DGA-1, DGA-2, and DGA-3, one pixel structure row is coupled to two gate lines GL, and one data line DL is coupled to at least two pixel structure columns. More specifically, in each of the dual-gate array substrates DGA-1, DGA-2, and DGA-3, a portion of the pixel structures PX in one pixel structure row is coupled to one gate line GL, and another portion of the pixel structures PX in the pixel structure row is coupled to another gate line GL. Also, one data line DL is coupled to at least a portion of the pixel structures PX in one pixel structure column, and the data line DL is further coupled to at least a portion of the pixel structures PX in another pixel structure column. Therefore, as compared to the single-gate array substrate SGA, the number of data lines DL in each of the dual-gate array substrates DGA-1, DGA-2, and DGA-3 can be reduced, and the number of gate lines GL can be increased. It is noted that the configuration of the gate lines GL, data lines DL, and pixel structures PX of the dual-gate array substrate of the present invention is not limited to FIG. 2A to FIG. 2C.

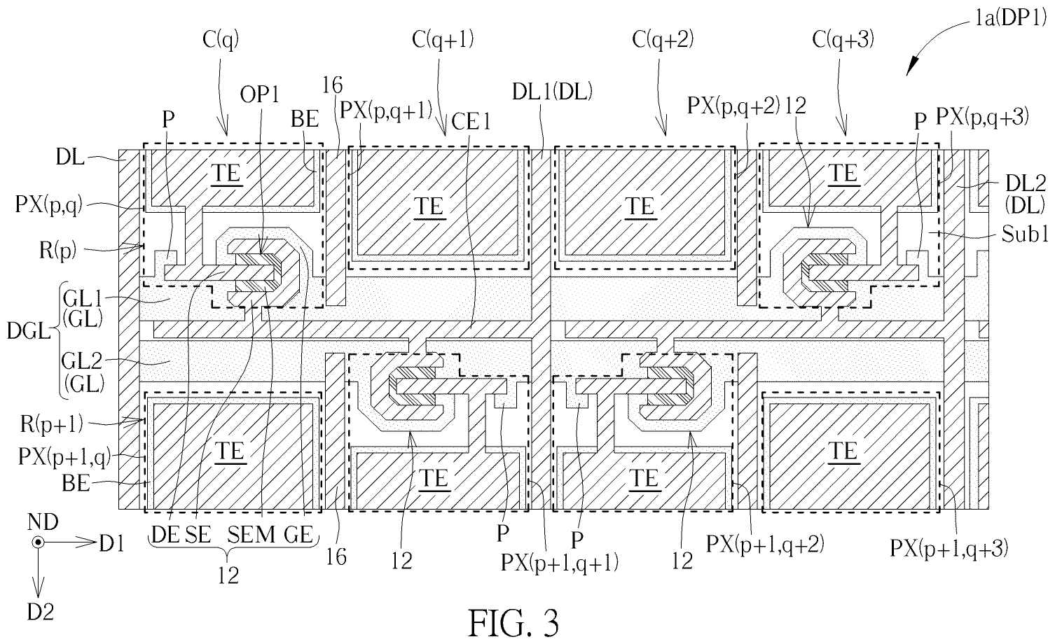

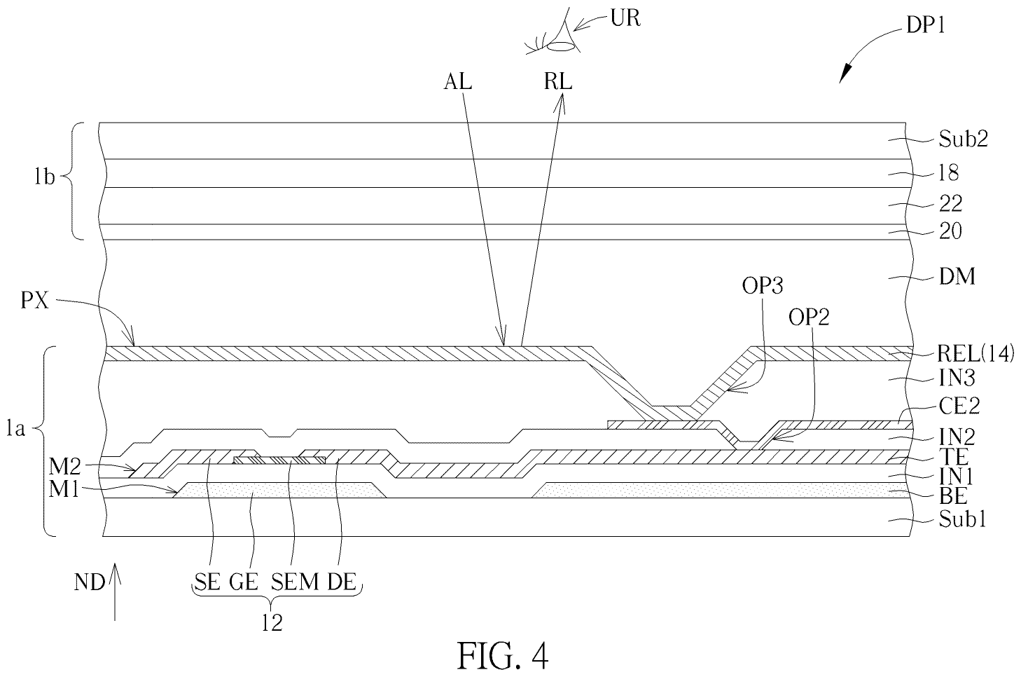

FIG. 3 schematically illustrates a partial top view of a dual-gate array substrate of a display panel according to the first embodiment of the present invention, and FIG. 4 is a partial cross-sectional schematic diagram of the display panel according to the first embodiment of the present invention. As shown in FIG. 3 and FIG. 4, the display panel DP1 provided in this embodiment may include a dual-gate array substrate 1a. As shown in FIG. 4, the display panel DP1 may further include a color filter substrate 1b and a display medium layer DM, wherein the color filter substrate 1b may be overlapped with the dual-gate array substrate 1a, and the display medium layer DM is disposed between the dual-gate array substrate 1a and the color filter substrate 1b. The display medium layer DM may be adjusted according to the type of display panel, and may include, for example, a liquid crystal layer, an electrophoretic layer, a light-emitting layer, an electrowetting medium or other suitable media.

As shown in FIG. 3 and FIG. 4, the dual-gate array substrate 1a may include a first substrate Sub1, a plurality of gate lines GL, a plurality of data lines DL, and a plurality of pixel structures PX. The pixel s PX include pixel structures PX(p, q), PX(p, q+1), PX(p, q+2), PX(p, q+3), PX(p+1, q), PX(p+1, q+1), PX(p+1, q+2), and PX(p+1, q+3) as shown in FIG. 3, wherein the gate lines GL, the data lines DL, and the pixel structures PX are disposed on the first substrate Sub1. In this embodiment, the gate line GL extends along a first direction D1, and the data line DL extends along a second direction D2 different from the first direction D1. The first direction D1 may be, for example, perpendicular to the second direction D2, but not limited thereto.

In order to clearly show the cross-sectional structure of the display panel DP1, a portion of the display panel DP1 corresponding to a single pixel structure PX is taken as an example in FIG. 4, but not limited thereto. As shown in FIG. 3 and FIG. 4, each of the pixel structures PX may include a thin film transistor 12 and a pixel electrode 14, wherein a gate GE of the thin film transistor 12 is coupled to a corresponding one of the gate lines GL, the source SE of the thin film transistor 12 is coupled to a corresponding one of a plurality of data lines DL, and the pixel electrode 14 is coupled to a drain DE of the thin film transistor 12. In order to clearly show the main structure of the dual-gate array substrate 1a, FIG. 3 omits some of layers (e.g., the gate insulating layer IN1, the insulating layers IN2, IN3, the connecting electrode CE2, and the pixel electrode 14) in FIG. 4.

Refer to FIG. 2C as well as FIG. 3. FIG. 3 is a partial layout diagram of the dual-gate array substrate DGA-3 of FIG. 2C, wherein the pixel structures PX in FIG. 2C may include the pixel structures PX(p, q), PX(p,q+1), PX(p,q+2), PX(p,q+3), PX(p+1,q), PX(p+1,q+1), PX(p+1, q+2), and PX(p+1, q+3) as shown in FIG. 3. In the embodiment of FIG. 3, the pixel structures of the dual-gate array substrate 1a may be arranged into a plurality of pixel structure rows and a plurality of pixel structure columns. The pixel structure rows include a pixel structure row R(p) and a pixel structure row R(p+1), and the pixel structure columns include pixel structure columns C(q), C(q+1), C(q+2), and C(q+3). The gate lines GL include a gate line GL1 and a gate line GL2 adjacent to each other (which form a group of dual gate lines DGL), and the data lines DL include a data line DL1 and a data line DL2 adjacent to each other, wherein p and q are positive integers. It is noted that the dual-gate array substrate 1a may include a plurality of groups of dual gate lines DGL, each group of dual gate lines DGL includes two adjacent gate lines GL, and the groups of dual gate lines DGL may be arranged in sequence along the second direction D2 (FIG. 3 only shows one group of dual gate lines DGL as an example). In addition, FIG. 3 illustrates a partial top view of the dual-gate array substrate 1a, and the thin film transistors 12 of the pixel structures PX(p, q+1), PX(p, q+2), PX(p+1, q), and PX(p+1, q+3) are omitted. The sources SE of the pixel structures PX(p, q) and PX(p+1, q+1) respectively in the pixel structure row C(q) and the pixel structure row C(q+1) may be coupled to the same data line DL1, and the sources SE of the pixel structures PX(p+1, q+2) and PX(p, q+3) respectively in the pixel structure row C(q+2) and the pixel structure row C(q+3) may be coupled to another data line DL2. The gate line GL1 may be coupled to the gates GE of the pixel structures PX(p, q) and PX(p, q+3) in the pixel structure row R(p), and the gates GE of the pixel structures PX(p, q+1) and PX(p, q+2) in the pixel structure row R(p) are coupled to another gate line (e.g., a gate line not shown and located on an upper side of the gate line GL1 in the opposite direction of the second direction D2 in FIG. 3). The gate line GL2 may be coupled to the gates GE of the pixel structures PX(p+1, q+1) and PX(p+1, q+2) in the pixel structure row R(p+1), and the gates of the pixel structures PX(p+1, q) and PX(p+1, q+3) in the pixel structure row R(p+1) are coupled to another gate line (e.g., a gate line not shown and located on a lower side of the gate line GL2 in the second direction D2 in FIG. 3). The connecting configuration of the gate lines GL, the data lines DL and the pixel structures of the present invention is not limited to the mentioned above.

In the embodiment of FIG. 3, the source SE and drain DE of each of the pixel structures PX(p+1, q+1) and PX(p, q+3) are sequentially arranged along the first direction D1, and the source SE and drain DE of each of the pixel structures PX(p, q) and PX(p+1, q+2) are sequentially arranged along an opposite direction of the first direction D1. In this embodiment, an orthographic projection outline of the source SE of each pixel structure onto the first substrate Sub1 may be a U-shape having an opening OP1, wherein the drain DE and source SE of each pixel structure are opposite to each other, and one end of the drain DE may extend into the opening OP1 of the corresponding source SE, but the shapes of the drain DE and source SE of the present invention are not limited thereto. In this content, the orthographic projection outline of a component onto the first substrate Sub1 may, for example, refer to a top view shape of the component projected onto the first substrate Sub1 along a direction parallel to a normal direction ND of the first substrate Sub1. In this embodiment, the openings OP1 of the sources SE of a portion of the pixel structures and the openings OP1 of the sources SE of another portion of the pixel structures may face toward opposite directions. For example, the openings OP1 of the sources SE of the pixel structures PX(p+1, q+1) and PX(p, q+3) face toward the first direction D1, while the openings OP1 of the sources SE of the pixel structures PX(p, q) and PX(p+1, q+2) faces toward the opposite direction of the first direction D1.

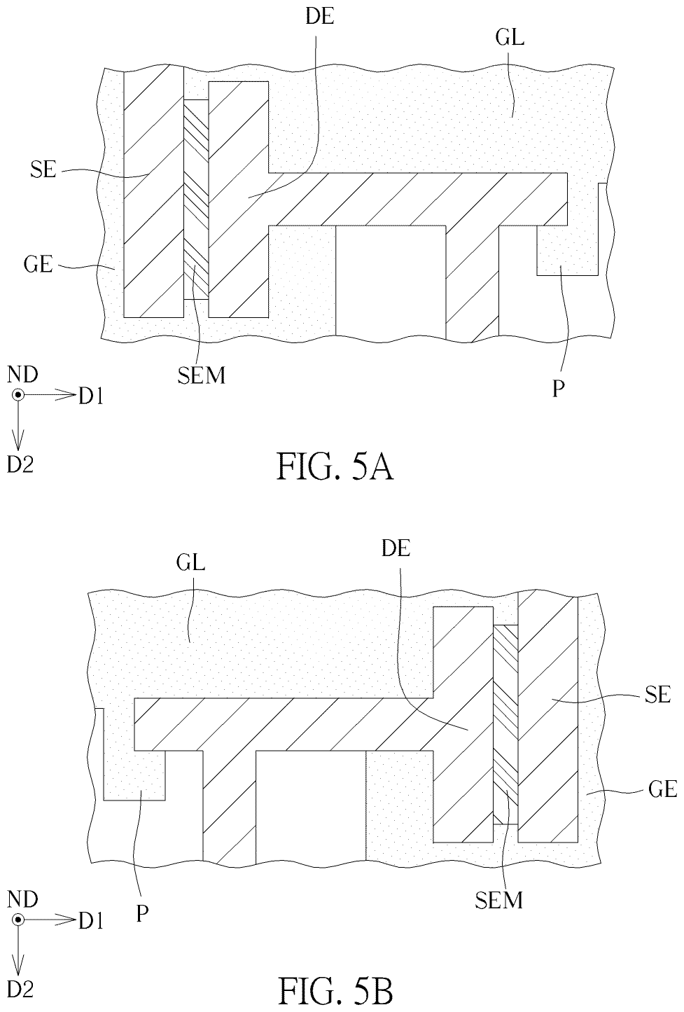

FIG. 5A and FIG. 5B respectively illustrate top views of another example of the thin film transistors of the pixel structures of the display panel according to the first embodiment. Refer to FIG. 5A and FIG. 5B. For example, FIG. 5A and FIG. 5B may be another example of the thin film transistors 12 of the pixel structures PX(p+1, q+1) and PX(p+1, q+2) in FIG. 3, respectively. As shown in FIG. 5A and FIG. 5B, the drain DE and the source SE may be opposite to each other, and each of them has a block shape. The source SE and the drain DE of the thin film transistor of the pixel structure in FIG. 5A are sequentially arranged along the first direction D1, while the source SE and the drain DE of the thin film transistor of the pixel structure in FIG. 5B are sequentially arranged in the opposite direction of the first direction D1.

As shown in FIG. 3, the gate GE of each thin film transistor 12 may be a part of the corresponding gate line GL (i.e., the gate line GL coupled thereto). In addition, each gate line GL may further have a plurality of protruding parts P, and the gates GE and the protruding parts P may protrude from the same side of the gate line GL, such that there is a gap between one of the gates GE and the corresponding protruding part P. In this case, the drain DE may extend from the position overlapped with the gate GE through the gap to the position overlapped with the corresponding protruding part P. That is, both ends of each drain DE may be overlapped with the corresponding gate GE and the corresponding protruding part P, respectively. Accordingly, when the relative position of the drain DE with respect to the gate GE of each pixel structure PX has an offset during manufacturing processes (e.g., during the process of manufacturing the drains DE, each drain DE is shifted relative to the corresponding gate GE in the first direction D1 or in the opposite direction of the first direction D1 due to the alignment error), the change of the overlapping area of the drain DE and the gate GE in the top view can be compensated by the change of the overlapping area of the drain DE and the protruding part P in the top view, thereby reducing the differences in coupling capacitance between the drain DE and the gate GE of different pixel structures PX. Accordingly, the differences in feed-through voltage between different pixel structures PX can be prevented to improve the brightness uniformity of the display panel DP1. In the embodiment of FIG. 3, the protruding parts P of the gate line GL1 and the gate line GL2 may protrude in opposite directions, respectively.

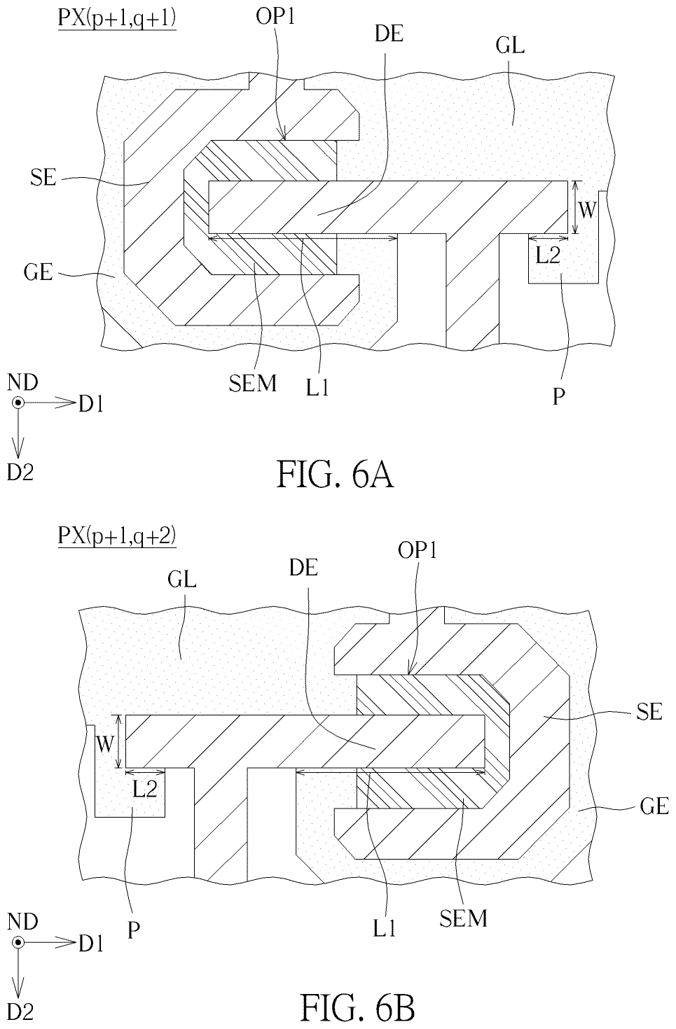

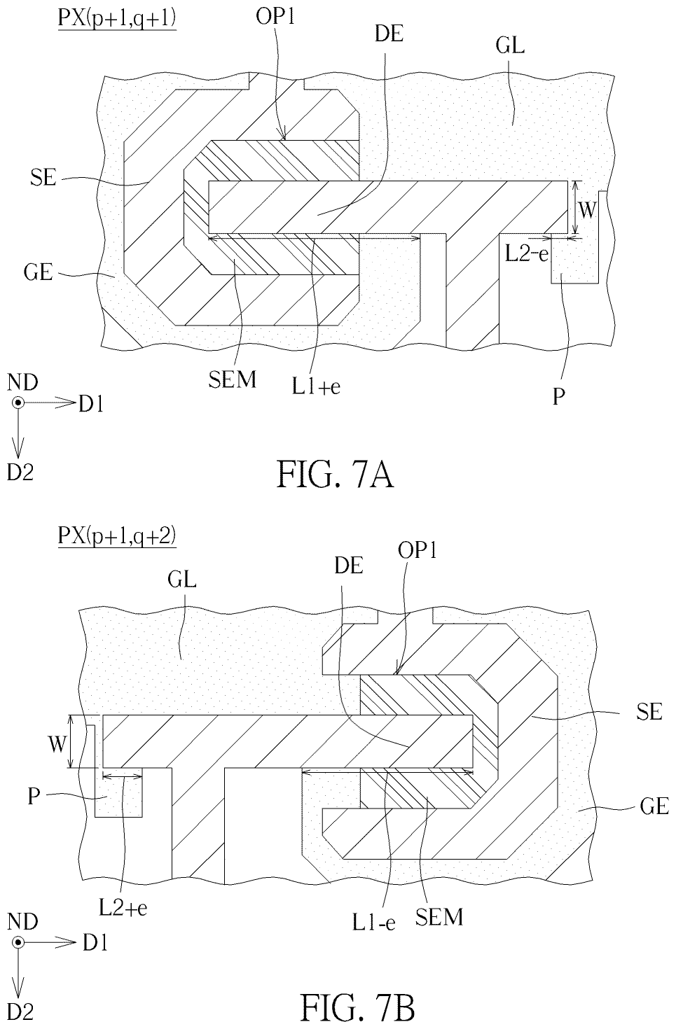

The compensation of the coupling capacitances described above is further described in the following content. FIG. 6A and FIG. 6B schematically illustrate partial top views of different pixel structures of FIG. 3 when there is no alignment error in the manufacturing processes, and FIG. 7A and FIG. 7B illustrate partial top views of different pixel structures of FIG. 3 when there is an alignment error in the manufacturing processes. Refer to FIG. 6A and FIG. 6B. FIG. 6A and FIG. 6B schematically illustrate partial top views of the pixel structure PX(p+1, q+1) and the pixel structure PX(p+1, q+2) respectively when there is no alignment error occurs in the relative positions of the drains DE with respect to the gates GE. The source SE and the drain DE of the pixel structure PX(p+1, q+1) are sequentially arranged along the first direction D1, while the source SE and the drain DE of the pixel structure PX(p+1, q+2) are sequentially arranged along the opposite direction of the first direction D1. That is, the openings OP1 of the sources SE of the pixel structure PX(p+1, q+1) and the pixel structure PX(p+1, q+2) face toward the opposite directions. In each of the pixel structure PX(p+1, q+1) and the pixel structure PX(p+1, q+2), the overlapping area of the drain DE and the gate GE of is a product of a width W and a partial length L1 of the drain DE, and the overlapping area of the drain DE and the protruding part P is a product of the width W and the partial length L2 of the drain DE. Refer to FIG. 7A and FIG. 7B. FIG. 7A and FIG. 7B schematically illustrate partial top views of the pixel structure PX(p+1, q+1) and the pixel structure PX(p+1, q+2) respectively when there is no alignment error occurs in the relative positions of the drains DE with respect to the gates GE. In FIG. 7A and FIG. 7B, each of the drains DE has an offset in the opposite direction of the first direction D1 relative to the gate GE, and the distance of the offset is e. It is noted that since the drains DE and the sources SE belong to the same metal layer, the drains DE and the sources SE in FIG. 7A and FIG. 7B are simultaneously shifted in the opposite direction of the first direction D1 as compared to FIG. 6A and FIG. 6B. As shown in FIG. 7A and FIG. 7B, the overlapping area between the drain DE and the gate GE of the pixel structure PX(p+1, q+1) is the product of the width W and the partial length (L1+e) of the drain DE, while the overlapping area between the drain DE and the gate GE of the pixel structure PX(p+1, q+2) is the product of the width W and the partial length (L1−e) of the drain DE. However, because the overlapping area between the drain DE and the protruding part P of the pixel structure PX(p+1, q+1) is the product of the width W and the partial length (L2−e) of the drain DE, and the overlapping area between the drain DE and the protruding part P of the pixel structure PX(p+1, q+2) is the product of the width W and the partial length (L2+e) of the drain DE, the sum of the overlapping area between the drain DE and the gate GE and the overlapping area between the drain DE and the protruding part P of the pixel structure PX(p+1, q+1) may be the same as the sum of the overlapping area between the drain DE and the gate GE and the overlapping area between the drain DE and the protruding part P of the pixel structure PX(p+1, q+2). Similarly, in the embodiment where the drain DE is shifted in the first direction D1 relative to the gate GE (not shown), the sum of the overlapping area between the drain DE and the gate GE and the overlapping area between the drain DE and the protruding part P of the pixel structure PX(p+1, q+1) may be the same as the sum of the overlapping area between the drain DE and the gate GE and the overlapping area between the drain DE and the protruding part P of the pixel structure PX(p+1, q+2). Therefore, by adding the protruding parts P, the differences in coupling capacitance between the drain DE and the gate GE of different pixel structures PX can be compensated when the alignment of the manufacturing process is shifted, so as to improve the image quality of the display panel DP1.

In the embodiment of FIG. 3 and FIG. 4, the gate lines GL may, for example, be formed of a first metal layer M1. The sources SE and the drains DE of the thin film transistors 12 and the data lines DL may, for example, be formed of a second metal layer M2. Each thin film transistor 12 may further include a semiconductor layer SEM and a gate insulating layer IN1. The semiconductor layer SEM is overlapped with the gate GE, and in a top view of the display panel DP1, a portion of the semiconductor layer SEM is located between the source SE and the drain DE to serve as a channel of the thin film transistor 12. The gate insulating layer IN1 may be disposed between the gate GE and the semiconductor layer SEM. The semiconductor layer SEM may be formed of a semiconductor material. In this content, the top view of the display panel may, for example, refer to the display panel viewed in a direction parallel to the normal direction ND of the first substrate Sub1.

In addition, each pixel structure PX may optionally further include an upper electrode TE and a lower electrode BE, wherein in the top view of the display panel DP1, the upper electrode TE may be overlapped and coupled with the lower electrode BE to form a storage capacitor. The upper electrode TE may be coupled to the drain DE of the corresponding thin film transistor 12. In this embodiment, the upper electrode TE and the drain DE may be formed by the same second metal layer M2, the lower electrode BE and the gate GE may be formed by the same first metal layer M1, and the lower electrode BE and the gate GE are electrically insulated from each other, but not limited thereto. In FIG. 4, a portion of the gate insulating layer IN1 may be disposed between the upper electrode TE and the lower electrode BE, so that the upper electrode TE, the lower electrode BE and the portion of the gate insulating layer IN1 may form the storage capacitor, but not limited thereto. In some embodiments, the number of insulating layers between the upper electrode TE and the lower electrode BE may be adjusted according to requirements. In addition, in other embodiments that are not shown, the pixel structure PX may not include the upper electrode TE and the lower electrode BE.

As shown in FIG. 3, the dual-gate array substrate 1 may optionally further include a plurality of connecting electrodes CE1 for coupling the sources SE of the pixel structures to the same data line DL. For example, the source SE of the pixel structure PX(p, q) located in the pixel structure row R(p) and the pixel structure column C(q) and the source SE of the pixel structure PX(p+1, q+1) located in the pixel structure row R(p+1) and the pixel structure column C(q+1) may be coupled to the corresponding data line DL1 through one connecting electrode CE1. In the top view, a portion of the connecting electrode CE1 may be located between two adjacent gate lines GL. For example, the connecting electrode CE1 coupled to the data line DL1 may be located between the gate line GL1 and the gate line GL2. The connecting electrode CE1 may, for example, be formed of the second metal layer (e.g., the second metal layer M2 shown in FIG. 4) or other metal layers.

In FIG. 3, the second metal layer of the dual-gate array substrate 1a (i.e., the second metal layer M2 of FIG. 4) may further optionally include a plurality of dummy electrodes 16 to provide uniformity of the second metal layer so as to improve the flatness of a layer formed on the second metal layer. The dummy electrodes 16 may be electrically floating. The dummy electrodes 16 may, for example, extend along the second direction D2. Each of the dummy electrodes 16 may be respectively disposed between two adjacent data lines DL and between two pixel structures in the same pixel structure row, but not limited thereto.

Furthermore, the dual-gate array substrate 1a may optionally further include an insulating layer IN2 and an insulating layer IN3 sequentially disposed on the thin film transistor 12 and the upper electrode TE, and the pixel electrode 14 may be disposed on the insulating layer IN3. In the embodiment of FIG. 4, each pixel structure PX may optionally further include another connecting electrode CE2 coupled between the pixel electrode 14 and the upper electrode TE, but not limited thereto. The insulating layer IN2 may have an opening OP2, such that the connecting electrode CE2 may be coupled to the upper electrode TE through the opening OP2. The insulating layer IN3 may have an opening OP3, so that the pixel electrode 14 may be coupled to the connecting electrode CE2 through the opening OP3, thereby coupling the pixel electrode 14 with the upper electrode TE and the corresponding drain DE through the opening OP3 and the opening OP2. In other embodiments not shown, each pixel structure PX may not include the connecting electrode CE2, and the pixel electrode 14 may be directly coupled to the upper electrode TE.

In the embodiment of FIG. 4, the display panel DP1 may be a reflective-type display panel, and each of the pixel electrodes 14 may include a light reflecting layer REL. The light reflecting layer REL may be a metal layer, and a material of the metal layer may include, for example, silver, aluminum, or other suitable materials with high reflectivity. In some embodiments, each of the pixel electrodes 14 may further include at least one transparent conductive layer (not shown in FIG. 4) disposed between the light reflecting layer REL and the insulating layer IN3 and/or disposed on a surface of the light reflecting layer REL opposite to the insulating layer IN3, so as to increase adhesion between the light reflecting layer REL and the insulating layer IN3 and/or to cover the light reflecting layer REL to prevent the light reflecting layer REL from being oxidized or sulfurized which may reduce the reflectivity. The light reflecting layer REL is used to reflect ambient light AL (or light from the front light module) to form reflected light RL, and the reflected light RL is transmitted to the eyes of the user UR to display the corresponding image. The display medium layer DM in the reflective-type display panel takes the liquid crystal layer as an example in FIG. 4, but not limited thereto. In the embodiment that the display medium layer DM in the reflective-type display panel is the electrophoretic layer, the ambient light (or the light from the front light module) is reflected by the electrophoretic particles in the electrophoretic layer to form the reflected light. It is noted that the types of the display panel DP1 of this embodiment are not limited thereto. The configuration and design of the pixel structures PX, the coupling configuration of the pixel structures PX with the gate lines GL and the data lines DL, and the compensation design in the coupling capacitance in the dual-gate array substrate 1a of this embodiment may be applied to display panels of other types (such as but not limited to a transmissive display panel or an organic light-emitting display panel) and are not be repeated herein.

The color filter panel 1b may include a second substrate Sub2 and a plurality of color filters 18, wherein the color filters 18 are respectively overlapped with the pixel structures PX. The color filters 18 may be disposed on a surface of the second substrate Sub2 facing the display medium layer DM. In this embodiment, the color filter panel 1b may further include a common electrode 20 disposed on surfaces of the color filters 18 facing the display medium layer DM. In other embodiments that are not shown, the common electrode 20 may be disposed in the dual-gate array substrate 1a. Electric fields between the pixel electrodes 14 and the common electrode 20 may control the state of the display dielectric layer DM. For example, in the embodiment that the display medium layer DM is the liquid crystal layer, the electric fields between the pixel electrodes 14 and the common electrode 20 may control rotating directions of the liquid crystal molecules in the liquid crystal layer.

The color filter panel 1b may optionally further include an overcoat layer 22 disposed between the color filters 18 and the common electrode 20. The overcoat layer 22 may, for example, serve as a flat layer, and a surface of the overcoat layer 22 facing the display medium layer DM may be a flat surface, so that the common electrode 20 may be formed on the flat surface. The overcoat layer 22 may include, for example, an organic insulating material. In some embodiments, the color filter panel 1b may optionally include a black matrix disposed between the second substrate Sub2 and the overcoat layer 22, but not limited thereto.

The display panel of the present invention is not limited to the above embodiment. Other embodiments of the present invention are further disclosed in the following content. In order to simplify the description and clarify differences between the embodiments, same symbols are used to label same components in the following content, and repeated parts will not be described again.

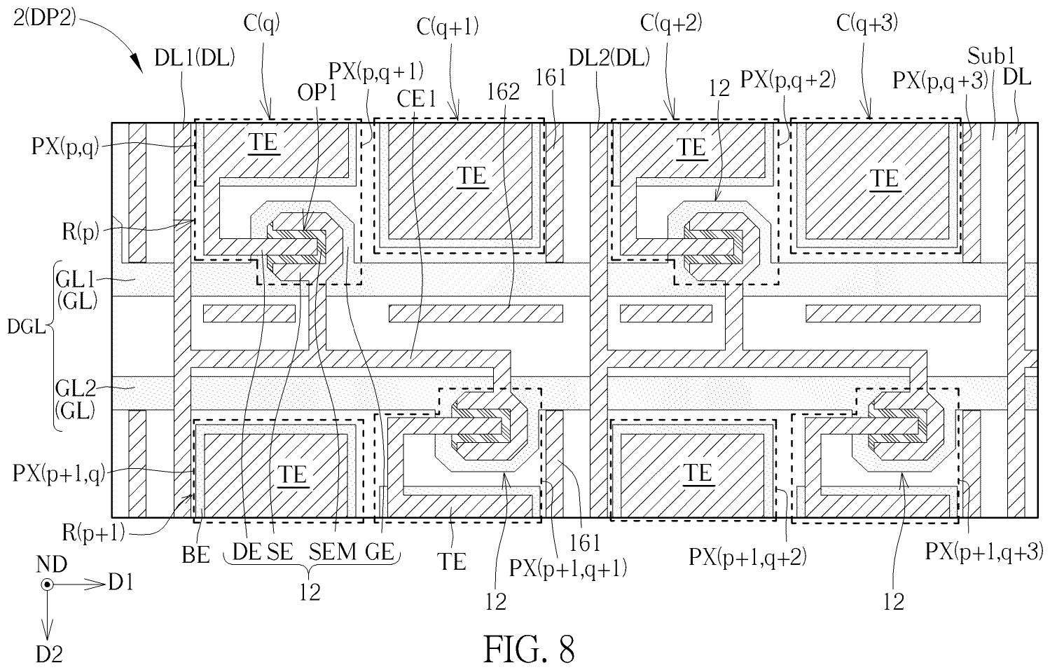

FIG. 8 schematically illustrates a partial top view structure of a display panel according to a second embodiment of the present invention. As shown in FIG. 8, the display panel DP2 provided in this embodiment differs from the display panel DP1 of FIG. 3 in that the source SE and the drain DE of each pixel structure in this embodiment may be arranged sequentially along the same direction. A schematic cross-sectional view of the display panel DP2 of this embodiment may be referenced in FIG. 4 and will not be described again herein. Refer to both FIG. 2B and FIG. 8. FIG. 8 may be a partial layout diagram of the dual-gate array substrate DGA-2 of FIG. 2B. The display panel DP2 includes a dual-gate array substrate 2, which includes a plurality of pixel structures, such as including pixel structures PX(p, q), PX(p,q+1), PX(p,q+2), PX(p,q+3), PX(p+1,q), PX(p+1,q+1), PX(p+1, q+2), PX(p+1, q+3). The sources SE of the pixel structures PX(p, q) and PX(p+1, q+1) respectively in the pixel structure column C(q) and the pixel structure column C(q+1) may be coupled to the same data line DL1, and the sources SE of the pixel structures PX(p, q+2) and PX(p+1, q+3) respectively in the pixel structure column C(q+2) and the pixel structure column C(q+3) may be coupled to another data line DL2. The gate line GL1 may be coupled to the gates GE of the pixel structures PX(p, q) and PX(p, q+2) in the pixel structure row R(p), while the gates GE of the pixel structures PX(p, q+1) and PX(p, q+3) in the pixel structure row R(p) may be coupled to another gate line (e.g., a gate line not shown and located on the upper side of the gate line GL1 in the opposite direction of the second direction D2 in FIG. 8). The gate line GL2 may be coupled to the gates GE of the pixel structures PX(p+1, q+1) and PX(p+1, q+3) in the pixel structure row R(p+1), while the gates of the pixel structures PX(p+1, q) and PX(p+1, q+2) in the pixel structure row R(p+1) may be coupled to another gate line (e.g., the gate line not shown and located on the lower side of the gate line GL2 in the second direction D2 in FIG. 8). In this embodiment, the source SE and the drain DE of each pixel structure PX are sequentially arranged along the same direction. It should be noted that although FIG. 8 only shows the thin film transistors 12 of the pixel structures PX(p, q), PX(p+1, q+1), PX(p, q+2), PX(p+1, q+3), and the thin film transistors of the pixel structures PX(p, q+1), PX(p,q+3), PX(p+1,q), PX(p+1,q+2) are omitted, the source SE and drain DE of each of the thin film transistors 12 of all pixel structures of the dual-gate array substrate 2 are sequentially arranged along the same direction. As shown in FIG. 8, the source SE and the drain DE of each pixel structure may, for example, be arranged sequentially along the opposite direction of the first direction D1, but not limited thereto. In other embodiments not shown, the source SE and the drain DE of each pixel structure may be arranged along the first direction D1, the second direction D2, the opposite direction of the second direction D2 or another direction not parallel to the first direction D1 and the second direction D2. More specifically, the directions of the openings OP1 of the sources SE of the pixel structures are the same, that is, the openings OP1 of the sources SE of the pixel structures PX all face toward the same direction (e.g., face toward the opposite direction of the first direction D1 in FIG. 8). In other words, in the top view of the display panel DP2, the gates GE of different thin film transistors 12 respectively have sides facing toward the same direction, and each of the drains DE may extend from the outside of a corresponding one of the gates GE through the side thereof to be overlapped with the corresponding gate GE. It is noted that through the disposition that the sources SE and the drains DE are arranged sequentially along the same direction, when the relative positions of the sources SE and the drains DE with respect to the gates GE of the pixel structures are shifted during the manufacturing process, for example, shifted in the first direction D1, the overlapping areas of the drains DE and the gates GE of different pixel structures in the top view can be increased or decreased simultaneously, thereby reducing differences in the coupling capacitance between the drain DE and the gate GE of different pixel structures. Therefore, the feed-through voltages of different pixel structures may be the same, thereby improving the brightness uniformity of the display panel DP2.

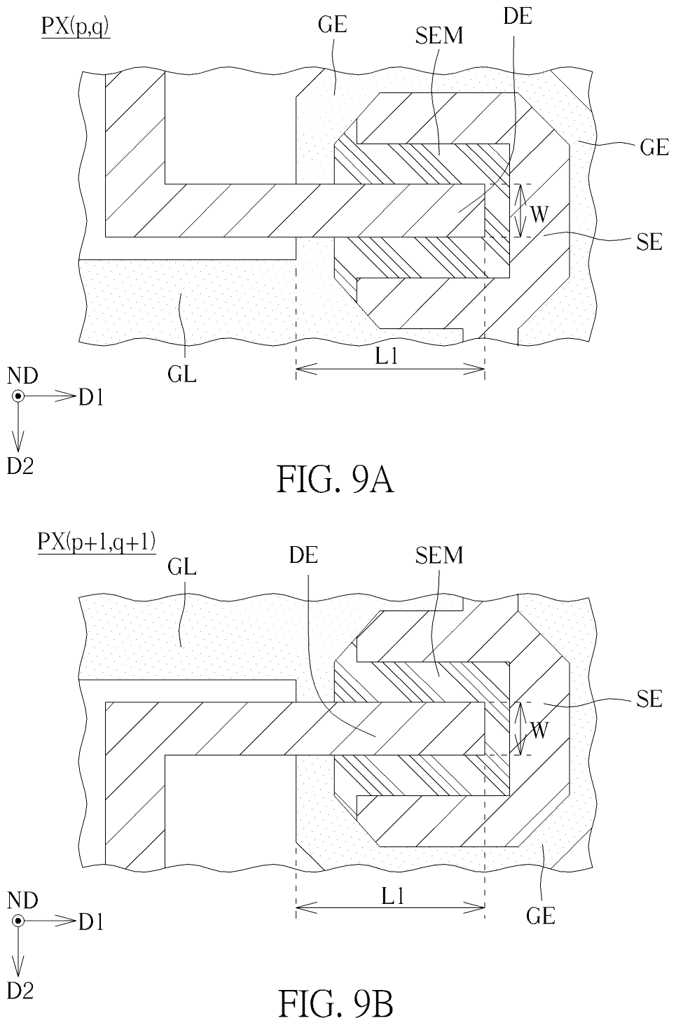

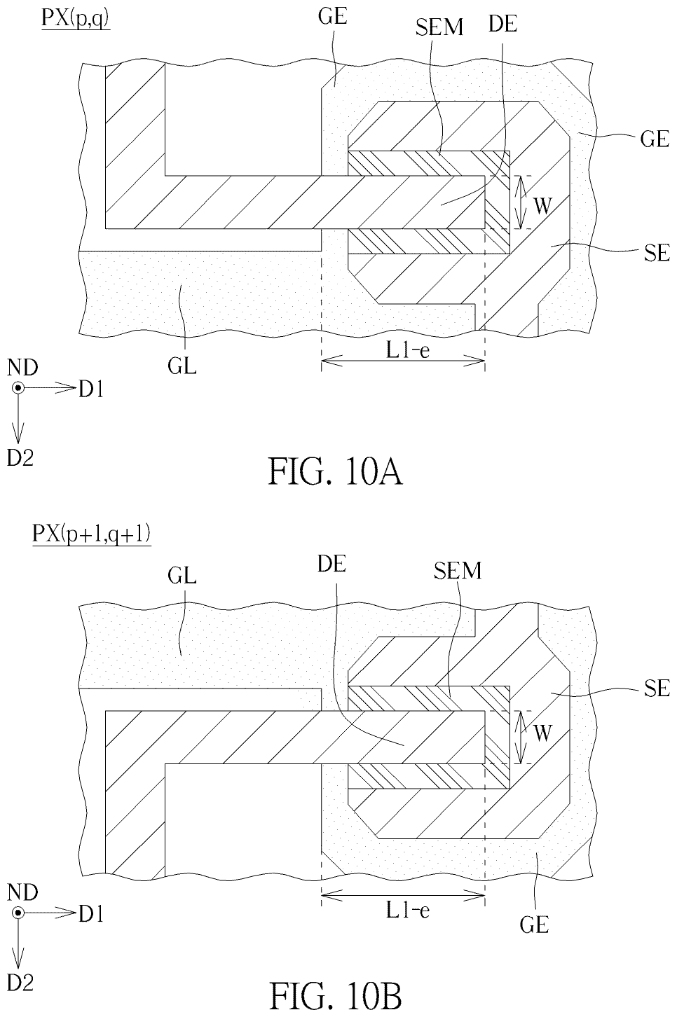

The following content further details advantage of sequentially arranging the source SE and the drain DE of each pixel structure along the same direction mentioned above. FIG. 9A and FIG. 9B schematically illustrate partial top views of different pixel structures of FIG. 8 when there is no alignment error in the manufacturing processes. FIG. 10A and FIG. 10B schematically illustrate partial top views of different pixel structures of FIG. 8 when there is an alignment error in the manufacturing processes. Refer to FIG. 9A and FIG. 9B. FIG. 9A and FIG. 9B respectively are schematic partial top view diagram of the pixel structures PX(p, q) and PX(p+1, q+1) of the dual-gate array substrate 2 when there is no alignment error occurs in the relative positions of the drains DE with respect to the gates GE. Although FIG. 9A and FIG. 9B only take two different pixel structures as an example, the overlapping area of the drain DE and the gate GE of any pixel structure of the dual-gate array substrate 2 is the product of the width W and the partial length L1 of the drain DE. Refer to FIG. 10A and FIG. 10B. FIG. 10A and FIG. 10B respectively are schematic partial top view diagram of the pixel structures PX(p, q) and PX(p+1, q+1) of the dual-gate array substrate 2 when there is an alignment error occurs in the relative positions of the drains DE with respect to the gates GE. In FIG. 10A and FIG. 10B, the drain DE has an offset in the opposite direction of the first direction D1 relative to the gate GE, and the distance of the offset is e. Therefore, the overlapping area of the drain DE and the gate GE of each pixel structure of the dual-gate array substrate 2 is the product of the width W and the partial length (L1−e) of the drain DE. Similarly, in the embodiment that the drain DE has the offset in the first direction D1 (not shown) relative to the gate GE and the distance of the offset is e, the overlapping area of the drain DE and the gate GE of each pixel structure of the dual-gate array substrate 2 is the product of the width W and the partial length (L1+e) of the drain DE. Therefore, by arranging the source SE and the drain DE of each pixel structure of the dual-gate array substrate 2 sequentially along the same direction, even when the alignment of the manufacturing processes is shifted, the coupling capacitances between the drain DE and the gate GE of different pixel structures are the same, such that the feedthrough voltages of different pixel structures are the same, and the image quality of the display panel DP2 can be improved.

In this embodiment, since the source SE and the drain DE of each pixel structure are sequentially arranged along the same direction, each gate line GL may optionally not have the protruding parts P of FIG. 3. In this case, the orthographic projection outline of each drain DE onto the first substrate Sub1 may be, for example, L-shaped. In some embodiments, each gate line GL of FIG. 8 may include the protruding parts P of FIG. 3.

In the embodiment of FIG. 8, the orthographic projection outline of the source SE of each pixel structure onto the first substrate Sub1 may be, for example, U-shaped. In this case, each U-shaped opening OP1 faces toward the same direction, for example, toward the opposite direction of the first direction D1. In some embodiments, each U-shaped opening OP1 may face toward the first direction D1, the second direction D2, the opposite direction of the second direction D2, or another direction that is not parallel to the first direction D1 and second direction D2. In some embodiments, the orthographic projection outline of each source SE onto the first substrate Sub1 may not be U-shaped, but may be a block shape parallel to the drain DE (refer to FIG. 5A and FIG. 5B), but not limited thereto.

In some embodiments, the second metal layer (e.g., the second metal layer M2 in FIG. 4) of the dual-gate array substrate 2 may optionally further include a plurality of dummy electrodes 161 and a plurality of dummy electrodes 162 to provide uniformity of the second metal layer, thereby improving the flatness of the layer formed on the second metal layer. The dummy electrodes 161 and the dummy electrodes 162 may be electrically floating. The dummy electrodes 161 and the dummy electrodes 162 may, for example, extend along the second direction D2 and the first direction D1, respectively. The dummy electrodes 161 may be disposed on both sides of the same data line and between two adjacent pixel structures PX in the same pixel structure row, but not limited thereto. The dummy electrodes 162 may be disposed between two gate lines GL between two adjacent pixel structure rows, but not limited thereto. Since other parts of the display panel DP2 of this embodiment may be the same or similar to the embodiments of FIG. 3 and FIG. 4, they may be referenced in the content mentioned above and will not be detailed herein.

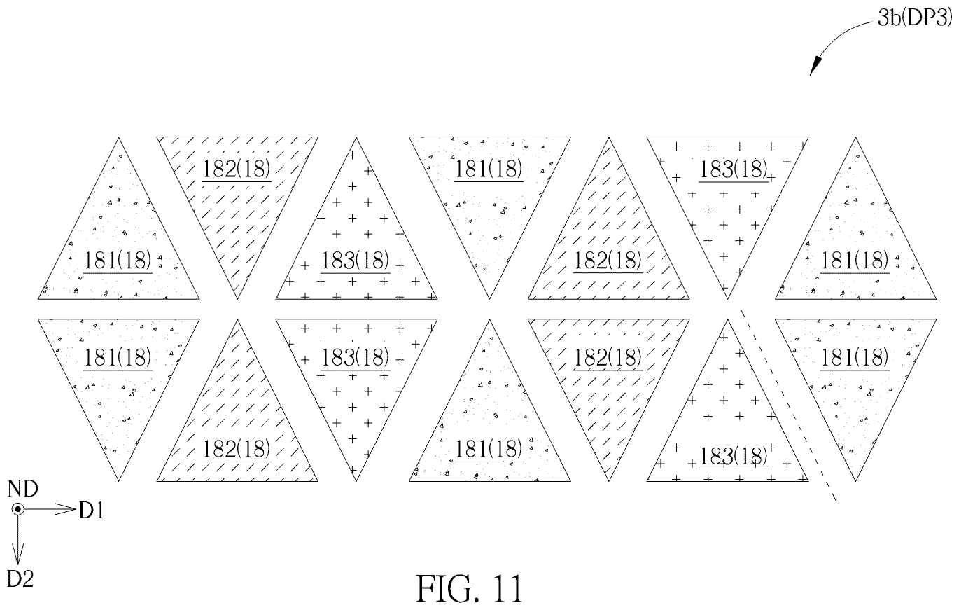

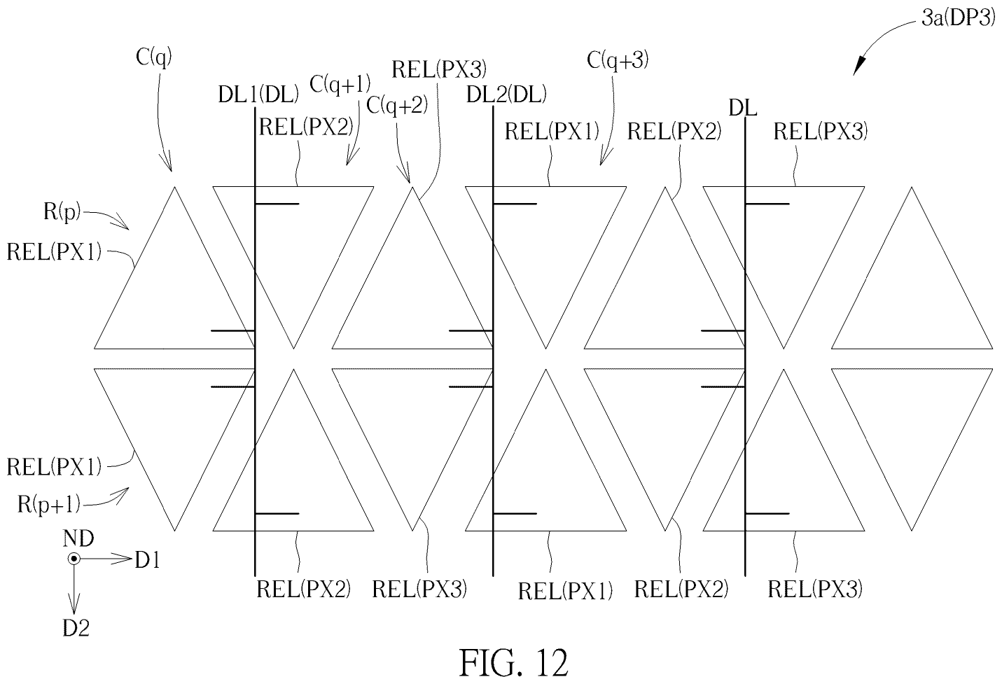

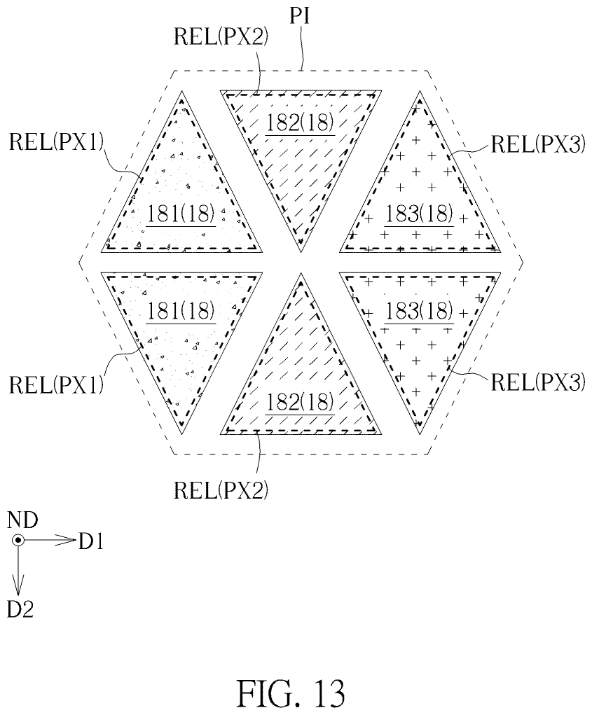

The configuration of a dual-gate array substrate and a color filter substrate adapted to a reflective-type display panel is further described below. FIG. 11 schematically illustrates a partial top view of a color filter substrate of a reflective-type display panel according to a third embodiment of the present invention. FIG. 12 schematically illustrates a partial top view of a dual-gate array substrate of the reflective-type display panel according to the third embodiment of t the invention. FIG. 13 schematically illustrates a top view of a pixel of the reflective-type display panel according to the third embodiment of the present invention. As shown in FIG. 11 and FIG. 12, the reflective-type display panel DP3 provided in this embodiment may include a dual-gate array substrate 3a and a color filter substrate 3b. A schematic cross-sectional view of the reflective-type display panel DP3 of this embodiment may be referenced in FIG. 4 and will not be repeated herein. It is noted that the color filter substrate 3b in FIG. 11 merely shows the color filters 18 and omits a second substrate and other layers disposed thereon, and the dual-gate array substrate 3a in FIG. 12 just shows the data lines DL and the light reflecting layer REL and omits a first substrate and other layers disposed thereon. The color filters 18 of the color filter substrate 3b may include a plurality of first color filters 181, a plurality of second color filters 182, and a plurality of third color filters 183, and an orthographic projection outline of each of the first color filters 181, the second color filters 182 and the third color filters 183 onto the second substrate (e.g., the second substrate Sub2 of FIG. 4) is a triangle. An orthographic projection outline of the light reflecting layer REL of each pixel structure of the dual-gate array substrate 3a onto the first substrate (e.g., the first substrate Sub1 of FIG. 4) is a triangle, and each color filter 18 may be overlapped with the light reflecting layer REL of the corresponding one pixel structure in the normal direction ND. Through the design of dual gate lines combined with the design of the triangular-shaped light reflecting layer REL of each pixel structure and the triangular-shaped color filter 18, the arrangement of the pixel structures may be closer, so that greater number of the pixel structures may be provided in a display region of the reflective-type display panel DP3. In particular, a distance between adjacent color filters 18 in FIG. 11 and a distance between adjacent light reflecting layers REL in FIG. 12 are enlarged in order to clearly describe the features of the present invention, but in actual products, the arrangement of adjacent color filters 18 and the arrangement of adjacent light reflecting layers REL may be closer. For example, the distance between adjacent light reflective layers REL may be less than or equal to 3 micrometers, but not limited thereto. Therefore, in the case of the same area of an active region or the display region, a larger number of pixel structures may be provided in the reflective-type display panel DP3 of this embodiment, that is, each pixel displayed by the reflective-type display panel DP3 may be reduced to improve the fineness of the images.

In the embodiment of FIG. 11, the first color filter 181, the second color filter 182 and the third color filter 183 may respectively have different colors, for example, one, another one and the other one of the first to third color filters 181, 182 and 183 respectively have red, green and blue colors, or the first to third color filters 181, 182 and 183 are combinations of other colors. The color filters 18 may be arranged into a plurality of rows and a plurality of columns, wherein the first color filters 181, the second color filters 182 and the third color filters 183 are respectively arranged in different columns. In other words, the color filters 18 of the same column may have the same color and be the first color filters 181, the second color filters 182 or the third color filters 183. In the same row, the first color filters 181, the second color filters 182 and the third color filters 183 may be sequentially arranged along the first direction D1. In some embodiments, the arrangement order of the first color filters 181, the second color filters 182, and the third color filters 183 is not limited to FIG. 11 and may be adjusted according to requirements.

Similarly, as shown in FIG. 12, the dual-gate array substrate 3a may include a plurality of first pixel structures PX1, a plurality of second pixel structures PX2 and a plurality of third pixel structures PX3, wherein the shapes of orthographic projection outlines of the light reflecting layers REL of the first pixel structures PX1, the second pixel structures PX2 and the third pixel structure PX3 may be respectively the same as the shapes of the orthographic projection outlines of the first color filters 181, the second color filters 182 and the third color filters 183. The light reflecting layer REL of the first pixel structure PX1, the light reflecting layer REL of the second pixel structure PX2, and the light reflecting layer REL of the third pixel structure PX3 may be respectively overlapped with the first color filter 181, the second color filter 182 and the third color filter 183.

Furthermore, the reflective-type display panel DP3 may include a plurality of pixels. As shown in FIG. 13, in this embodiment, one of the pixels PI may include six pixel structures and corresponding color filters 18. More specifically, one pixel PI may include the light reflecting layers REL of six pixel structures and six color filters 18. The light reflecting layers RE of the above-mentioned six pixel structures are overlapped with the above-mentioned six color filters 18, respectively. For example, the pixel PI may include two adjacent first color filters 181 in the same column, two adjacent second color filters 182 in the same column, two adjacent third color filters 183 in the same column, the light reflecting layers REL of two adjacent pixel structures PX1 in the same column, the light reflecting layers REL of two adjacent pixel structures PX2 in the same column, and the light reflecting layers REL of two adjacent pixel structures PX3 in the same column. The pixel PI may be, for example, a hexagon.

In the pixel PI, a side of the triangular outline of one of two adjacent first color filters 181 and a side of the triangular outline of the other one of the two adjacent first color filters 181 are opposite to each other. A vertex of the triangular outline of one of two adjacent second color filters 182 and a vertex of the triangular outline of the other one of the two adjacent second color filters 182 are opposite to each other. A side of the triangular outline of one of two adjacent third color filters 183 and a side of the triangular outline of the other one of the two adjacent third color filters 183 are opposite to each other. Accordingly, the color filters 18 can be closely arranged. For example, the two adjacent first color filters 181 may be symmetrical to each other with respect to the first direction D1 as a symmetrical axis. Similarly, the two adjacent second color filters 182 may be symmetrical to each other with respect to the first direction D1, and the two adjacent third color filters 183 may be symmetrical to each other with respect to the first direction D1. Furthermore, a side of the triangular outline of the light reflecting layer REL of one of two adjacent first pixel structures PX1 and a side of the triangular outline of the light reflecting layer REL of the other one of the two adjacent first pixel structures PX1 are opposite to each other. A vertex of the triangular outline of the light reflecting layer REL of one of two adjacent second pixel structures PX2 and a vertex of the triangular outline of the light reflecting layer REL of the other one of the two adjacent second pixel structures PX2 are opposite to each other. A side of the triangular outline of the light reflecting layer REL of one of two adjacent third pixel structures PX3 and a side of the triangular outline of the light reflecting layer REL of the other one of the two adjacent third pixel structures PX3 are opposite to each other.

As shown in FIG. 12, the shape of the light reflecting layer REL of one of two pixel structures adjacent to each other along the second direction D2 in any pixel structure column is a vertical flip of the shape of the light reflecting layer REL of the other one of the two pixel structures, and the shape of the light reflecting layer REL of one of two pixel structures respectively in two adjacent pixel structure columns and adjacent to each other along the first direction D1 is a vertical flip of the shape of the light reflecting layer REL of the other one of the two pixel structures. For example, the shape of the light reflecting layer REL of the first pixel structure PX1 located in the pixel structure column C(q) and the pixel structure row R(p) in FIG. 12 is an equilateral triangle, and the shape of the light reflecting layer REL of the first pixel structure PX1 located in the pixel structure column C(q) and the pixel structure row R(p+1) and the shape of the light reflecting layer REL of the second pixel structure PX2 located in the pixel structure column C(q+1) and the pixel structure row R(p) are inverted triangles, so that adjacent light reflecting layers REL may be closely arranged (i.e., the distance between adjacent light reflecting layers REL is extremely small). In addition, the color filters 18 are respectively overlapped with and have the same shape as the light reflecting layers REL of the corresponding pixel structures, so the adjacent color filters 18 may also be closely arranged (i.e., the distance between the adjacent color filters 18 may be extremely small).

The array substrate of the reflective-type display panel DP3 of this embodiment (i.e., the dual-gate array substrate 3a) uses the design of the dual gate lines. As mentioned above, one data line DL of the dual-gate array substrate is coupled to at least two pixel structure columns. Accordingly, two adjacent pixel structure columns coupled to the same data line DL are taken as an example in FIG. 12 to illustrate the features of this embodiment. As shown in FIG. 12, the first pixel structures PX1 of the pixel structure column C(q) and the second pixel structures PX2 of the pixel structure column C(q+1) may be coupled to the same data line DL1, and the third pixel structures PX3 of the pixel structure column C(q+2) and the first pixel structures PX1 of the pixel structure column C(q+3) may be coupled to the same data line DL2. The arrangement and coupling configuration of the pixel structures and the data lines of the present invention are not limited to FIG. 12. In particular, in order to clearly describe the features of the present invention, FIG. 12 uses line segments coupling the data lines DL to the light reflecting layers REL of the pixel structures (i.e., bold line segments extending along the first direction D1 in FIG. 12) to represent electrical connecting relation between the data lines DL and the light reflecting layer REL of the corresponding pixel structures.

It is noted that one of the data lines DL extending along the second direction D2 may be overlapped with at least one pixel structure column (e.g., one data line DL in FIG. 12 may be overlapped with two adjacent pixel structure columns). In this case, at least a portion of the data lines DL is overlapped with at least a portion of the light reflecting layers REL in the normal direction ND of the first substrate, and the at least a portion of the light reflecting layers REL covers the at least a portion of the data lines DL (i.e., in the normal direction ND of the first substrate, the light reflecting layers REL are located between the data lines DL and the display medium layer and cover the data lines DL). By disposing the data lines DL under the light reflecting layers REL and arranging the light reflecting layers REL closely as mentioned above, the contrast decrease caused by the light reflection of the data lines DL can be avoided.

Since other parts of the reflective-type display panel DP3 of this embodiment may be the same as or similar to the embodiment of FIG. 3, FIG. 4 or FIG. 8, they may be referenced in the above content and will not be detailed herein. In some embodiments, the triangular outlines of the color filters 18 and the light reflecting layers of the pixel structures PX in FIG. 11 and FIG. 12 may be applied to the above-mentioned embodiment of FIG. 3, FIG. 4 or FIG. 8.

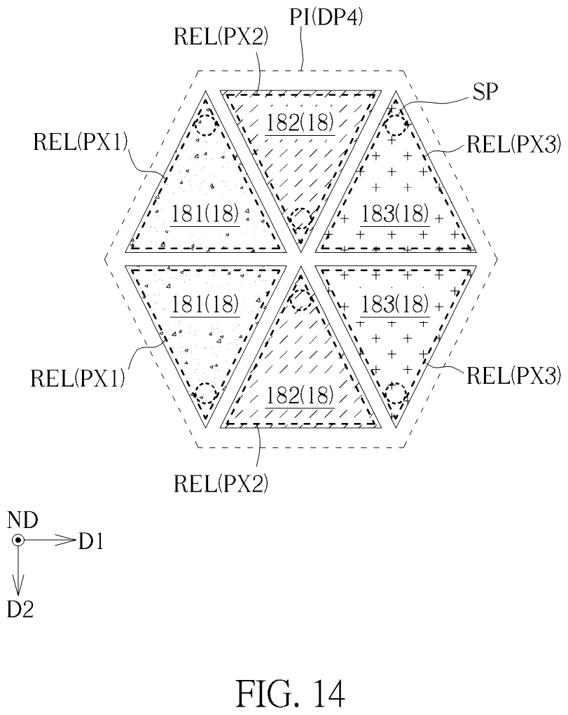

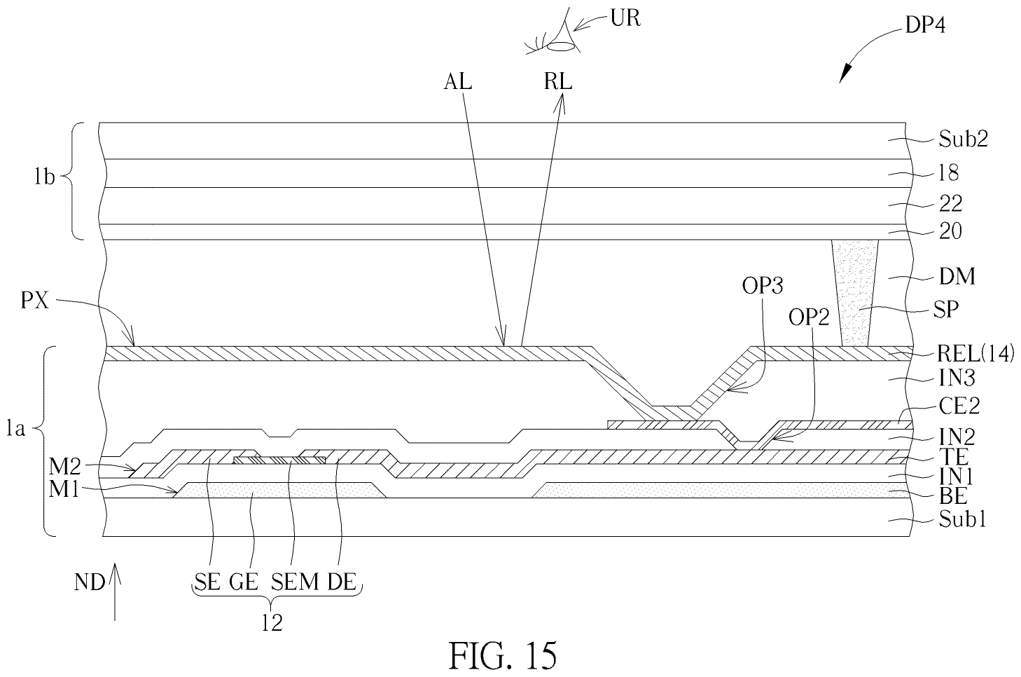

FIG. 14 schematically illustrates a top view of a pixel and spacers of a reflective-type display panel according to a fourth embodiment of the present invention. FIG. 15 schematically illustrates a partial cross-sectional schematic diagram of the reflective-type display panel according to the fourth embodiment of the present invention. As shown in FIG. 14 and FIG. 15, the reflective-type display panel DP4 provided by this embodiment further includes a plurality of spacers SP overlapped with the pixel structures of the pixel PI, respectively. The spacers SP are disposed between the dual-gate array substrate 1a and the color filter substrate 1b and may be used to support the dual-gate array substrate 1a and the color filter substrate 1b, so as to maintain thickness uniformity of the display medium layer DM and prevent image quality of the reflective-type display panel DP4 from being affected by the uneven thickness of the display medium layer DM caused by pressing the reflective-type display panel DP4. The spacer SP may be a main-spacer or a sub-spacer. The spacer SP is the main-spacer as an example in FIG. 15, but not limited thereto. In other embodiments that are not shown, the spacer SP may be the sub-spacer, and a height of the spacer SP in the normal direction ND is less than a height of the main spacer in the normal direction ND. In particular, one of the spacers SP is overlapped with a corner of one of the pixel structures of the pixel PI (i.e., a region close to the vertex of the triangular pixel structure). Specifically, as viewing the reflective-type display panel DP4 along a top view direction (e.g., viewing the reflective-type display panel DP4 along the normal direction ND), a distance between a center point of the spacer SP and the vertex of the triangular pixel structure may be less than a distance between the center point of the spacer SP and a center point of the triangular pixel structure. For example, the spacer SP may be disposed on the corner of the triangular-shaped light reflecting layer REL, so that comparing to the case that the spacer SP is closer to the center of the light reflecting layer REL, the part of the light reflecting layer REL close to the spacer SP of this embodiment may have less area, so as to avoid affecting light intensity of the reflected light RL. On the other hand, FIG. 14 takes each of the six pixel structures of the pixel PI overlapped with a corresponding one of the spacers SP as an example, but not limited thereto. In other embodiments that are not shown, some of the pixel structures of the pixel PI may be overlapped with the spacers SP, and the others of the pixel structures are not overlapped with the spacers SP. Furthermore, each pixel PI of the reflective-type display panel DP4 of this embodiment may be overlapped with the spacer SP, or some of the pixels PI and the others of the pixels PI of the reflective-type display panel DP4 may respectively be overlapped with the spacers SP and not be overlapped with the spacers SP.

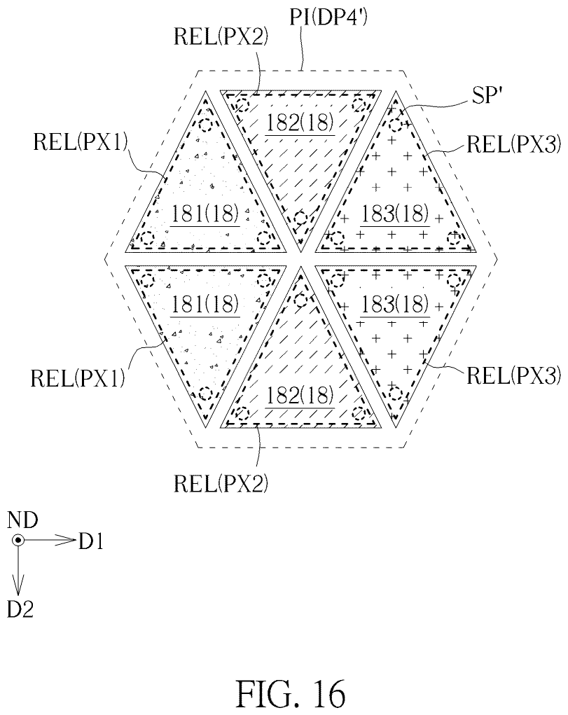

FIG. 16 schematically illustrates a top view of a pixel and spacers of a reflective-type display panel according to a variant embodiment of a fourth embodiment of the present invention. As shown in FIG. 16, this variant embodiment differs from FIG. 14 in that a plurality of corners (e.g., regions close to a plurality of vertices) of one of the pixel structures of the pixel PI of the reflective-type display panel DP4′ in this embodiment may be overlapped with a plurality of spacers SP′, respectively. For example, one of the spacers SP in FIG. 14 may be modified into the spacers SP′ that each has less area (e.g., the area viewed along the top view direction) than the one of the spacers SP, and the spacers SP′ are respectively overlapped with the corners of one of the pixel structures, so as to provide more uniform supporting force and avoid severely reducing the light intensity of the reflected light. Particularly, FIG. 16 takes all three corners of one of the triangular pixel structures of the pixel PI overlapped with the spacers SP′ as an example, but not limited thereto. In other embodiments that are not shown, two corners of the triangular-shaped pixel structure of the pixel PI may be respectively overlapped with the spacers SP′, and the other corner of the triangular-shaped pixel structure may not be overlapped with the spacers SP′.

In summary, in the display panel of the present invention, by providing protruding parts in the gate lines or arranging the source and the drain of each pixel structure sequentially along the same direction, when the relative positions of the source and the drain with respect to the gate of each pixel structure is shifted during manufacturing processes, the overlapping areas of the drains and the gates of different pixel structures may be unchanged or be increased or decreased simultaneously, thereby reducing the differences in coupling capacitance between the drain and the gate of different pixel structures. Accordingly, the brightness uniformity of the display panel can be improved. In addition, by designing the orthographic projection outlines of the light reflecting layers of the pixel structures and the color filters to be triangles, the display region of the display panel is easy to comply with design requirements, and greater number of pixel structures may be disposed in the display region to improve fineness of the images.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display panel, comprising:
a dual-gate array substrate comprising:
a first substrate;
a plurality of gate lines and a plurality of data lines disposed on the first substrate; and
a plurality of pixel structures disposed on the first substrate, and each of the pixel structures comprising:
a thin film transistor, wherein a gate of the thin film transistor is coupled to one of the gate lines, and a source of the thin film transistor is coupled to one of the data lines; and
a pixel electrode coupled to a drain of the thin film transistor,
wherein the source and the drain of each of the pixel structures are sequentially arranged along a same direction.

2. The display panel as claimed in claim 1, wherein the pixel structures are arranged into a plurality of pixel structure rows and a plurality of pixel structure columns, the pixel structure rows comprise a first pixel structure row, the pixel structure columns comprise a first pixel structure column and a second pixel structure column, the gate lines comprise a first gate line and a second gate line, the data lines comprise a first data line, the first gate line and the second gate line are coupled to the first pixel structure row, and the first data line is coupled to the first pixel structure column and the second pixel structure column.

3. The display panel as claimed in claim 1, wherein one of the gate lines extends along a first direction, and the source and the drain of each of the pixel structures are sequentially arranged along the first direction or an opposite direction of the first direction.

4. The display panel as claimed in claim 1, wherein an orthographic projection outline of the source of each of the pixel structure onto the first substrate is a U shape, each of the U shapes has an opening, and the openings of the U shapes face toward a same direction.

5. The display panel as claimed in claim 1, wherein the display panel is a reflective-type display panel.

6. The display panel as claimed in claim 1, wherein the display panel further comprises:
a color filter substrate overlapped with the dual-gate array substrate, wherein the color filter substrate comprises a second substrate and a plurality of color filters, the color filters are respectively overlapped with the pixel structures, and the color filters comprises a plurality of first color filters, a plurality of second color filters, and a plurality of third color filters,
wherein an orthographic projection outline of each of the first color filters, the second color filters and the third color filters onto the second substrate is a triangle.

7. The display panel as claimed in claim 6, wherein a side of a triangular outline of one of two adjacent first color filters and a side of a triangular outline of the other one of the two adjacent first color filters are opposite to each other, a vertex of a triangular outline of one of two adjacent second color filters and a vertex of a triangular outline of the other one of the two adjacent second color filters are opposite to each other, and a side of a triangular outline of one of two adjacent third color filters and a side of a triangular outline of the other one of the two adjacent third color filters are opposite to each other.

8. The display panel as claimed in claim 6, wherein the pixel structures comprise a plurality of first pixel structures, a plurality of second pixel structures, and a plurality of third pixel structures, each of the first pixel structures, the second pixel structures and the third pixel structures comprises a light reflecting layer, an orthographic projection outline of each of the light reflecting layers onto the first substrate is a triangle, and the first color filters, the second color filters, and the third color filters are respectively overlapped with the light reflecting layers of the first pixel structures, the light reflecting layers of the second pixel structures, and the light reflecting layers of the third pixel structures.

9. The display panel as claimed in claim 8, wherein the display panel comprises a plurality of pixels, each of the pixels comprises six of the pixel structures and six of the color filters, the six pixel structures are respectively overlapped with the six color filters, the six pixel structures comprise two of the first pixel structures, two of the second pixel structures, and two of the third pixel structures, and the six color filters comprise two of the first color filters, two of the second color filters, and two of the third color filters.

10. The display panel as claimed in claim 9, further comprising a spacer disposed between the dual-gate array substrate and the color filter substrate, wherein the spacer overlaps a corner of one of the six pixel structures of one of the pixels in a normal direction of the first substrate.

11. The display panel as claimed in claim 10, further comprising another spacer disposed between the dual-gate array substrate and the color filter substrate, wherein the another spacer overlaps another corner of the one of the six pixel structures of the one of the pixels in the normal direction of the first substrate.

12. The display panel as claimed in claim 8, wherein at least a portion of the data lines is overlapped with at least a portion of the light reflecting layers in a normal direction of the first substrate.
